(19) United States
(12) Patent Application Publication
(10) Pub. No.: US 2026/0243502 A1
(43) Pub. Date: Aug. 20, 2026

(54) ELECTRONIC APPARATUS AND TERMINAL APPARATUS FOR CALIBRATING NOISE AND/OR VIBRATION AND CONTROLLING METHODS THEREOF

(71) Applicant: SAMSUNG ELECTRONICS CO., LTD., Suwon-Si (KR)

(72) Inventors: Hyosuck KANG, Suwon-si (KR); Wonjun Jang, Suwon-si (KR); Youngseok Cho, Suwon-si (KR)

(73) Assignee: SAMSUNG ELECTRONICS CO., LTD., Suwon-si (KR)

(21) Appl. No.: 19/643,115

(22) Filed: Apr. 9, 2026

Related U.S. Application Data
(63) Continuation of application No. PCT/KR2024/015154, filed on Oct. 7, 2024.

(30) Foreign Application Priority Data
Oct. 25, 2023 (KR) 10-2023-0144097

(51) Int. Cl. F25D 29/00; G01H 11/08; G06F 3/0482; G06F 3/0484

(52) U.S. Cl. CPC F25D 29/00; G01H 11/08; G06F 3/0482; G06F 3/0484

(57) ABSTRACT

An electronic apparatus capable of diagnosing and calibrating noise and/or vibration is disclosed. The electronic apparatus includes a plurality of components, memory storing setting information for operations of each of the plurality of components, and a processor, and the processor is configured to, based on a test mode for diagnosing noise and/or vibration being executed, sequentially drive the plurality of components and select at least one of the plurality of components as a calibration target based on noise and/or vibration states of each of the plurality of components, and drive the component selected as the calibration target while sequentially changing an operation state thereof, and based on one operation state being selected, store setting information corresponding to the selected operation state in the memory.

### CROSS-REFERENCE TO RELATED APPLICATION(S)

This application is a by-pass continuation application of International Application No. PCT/KR2024/015154, filed on October 7, 2024, which is based on and claims priority to Korean Patent Application No. 10-2023-0144097, filed on October 25, 2023, in the Korean Intellectual Property Office, the disclosures of which are incorporated by reference herein in their entireties.

### BACKGROUND

### 1. Field

The present disclosure relates to an electronic apparatus and a terminal apparatus capable of calibrating noise and vibration, and to methods for calibrating the same.

### 2. Description of Related Art

With the development of electronic technology, various types of electronic apparatuses are used in general household environments. Electronic apparatuses that are generally used in home environments are commonly referred to as home appliances. A representative example of a home appliance may be a refrigerator.

A refrigerator includes components that perform rotation, such as a compressor or a fan. When such components rotate, noise and vibration may be generated. Since recent users consider not only the performance of home appliances but also quietness to be important, efforts to minimize noise and vibration have been continuously made.

However, since the degree to which noise or vibration is perceived differs from user to user, even when the refrigerator operates normally, noise or vibration may be annoying from the user’s perspective.

In preparation for such cases, there has arisen a need for a technology that allows a user to easily identify the cause of noise or vibration and to calibrate the same by himself or herself.

### SUMMARY

An electronic apparatus according to at least one embodiment includes a plurality of components, memory storing setting information for operations of each of the plurality of components, and a processor. The processor is configured to, based on a test mode for diagnosing noise and/or vibration being executed, sequentially drive the plurality of components and select at least one of the plurality of components as a calibration target based on noise and/or vibration states of each of the plurality of components, and drive the component selected as the calibration target while sequentially changing an operation state thereof, and based on one operation state being selected, store setting information corresponding to the selected operation state in the memory.

A terminal apparatus for diagnosing an operation state of an electronic apparatus according to at least one embodiment includes a communicator configured to perform communication with the electronic apparatus, memory storing an application for controlling operations of the electronic apparatus, a display, and a processor. The processor is configured to execute the application and control the display to display a UI screen corresponding to the electronic apparatus, based on a menu for diagnosing noise and/or vibration of the electronic apparatus being selected on the UI screen, control the communicator to transmit a control signal for initiating a test mode to the electronic apparatus, based on at least one component being designated through the UI screen while executing the test mode in the electronic apparatus and sequentially driving a plurality of components embedded in the electronic apparatus, control the communicator to transmit a control signal for driving the designated component while sequentially changing an operation state of the designated component to the electronic apparatus, and based on a specific operation state among operation states of the designated component being selected through the UI screen, control the communicator to transmit setting information corresponding to the selected operation state to the electronic apparatus.

A nose/vibration calibration method of an electronic apparatus including a plurality of components according to at least one embodiment includes, based on a test mode for diagnosing noise and/or vibration being executed, sequentially driving a plurality of components, based on at least one of the plurality of components being selected as a calibration target based on noise and/or vibration states of each of the plurality of components, driving the component selected as the calibration target while sequentially changing an operation state thereof, based on a specific operation state among operations states of the selected component being selected, storing setting information corresponding to the selected component, and based on the test mode being terminated, drive the plurality of components based on the stored setting information.

### BRIEF DESCRIPTION OF THE DRAWINGS

FIG. 1 is a view provided to explain operations of an electronic apparatus and a terminal apparatus according to at least one embodiment;

FIG. 2 is a block diagram illustrating configuration of an electronic apparatus according to at least one embodiment;

FIG. 3 is a block diagram illustrating configuration of a terminal apparatus according to at least one embodiment;

FIGS. 4 to 6 are views illustrating examples of a UI screen provided by a terminal apparatus;

FIG. 7 is a view provided to explain an operation of an electronic apparatus according to at least one embodiment;

FIG. 8 is a block diagram illustrating configuration of an electronic apparatus according to at least one embodiment;

FIG. 9 is a timing view provided to explain operations of an electronic apparatus and a terminal apparatus according to at least one embodiment;

FIG. 10 is a view provided to explain a method of calibrating noise in an electronic apparatus;

FIG. 11 is a view provided to explain a method of changing setting information for noise and/or vibration calibration; and

FIG. 12 is a flowchart provided to explain a noise and/or vibration calibration method according to at least one embodiment.

### DETAILED DESCRIPTION

The terms used in the present disclosure will be briefly described before the present disclosure is described in detail.

General terms that are currently widely used are selected as the terms used in the embodiments of the disclosure in consideration of their functions in the disclosure, but may be changed based on the intention of those skilled in the art or a judicial precedent, the emergence of a new technique, or the like. In addition, in a specific case, terms arbitrarily chosen by an applicant may exist, in which case, the meanings of such terms will be described in detail in the corresponding descriptions of the disclosure. Thus, the terms used in the embodiments of the disclosure need to be defined on the basis of the meanings of the terms and the overall contents throughout the disclosure rather than simple names of the terms.

In the disclosure, the expressions “have”, “may have”, “include” or “may include” used herein indicate existence of corresponding features (e.g., elements such as numeric values, functions, operations, or components), but do not exclude presence of additional features.

In the disclosure, the expressions “A or B”, “at least one of A or/and B”, or “one or more of A or/and B”, and the like may include any and all combinations of one or more of the items listed together. For example, the term “A or B”, “at least one of A and B”, or “at least one of A or B” may refer to all of the case (1) where at least one A is included, the case (2) where at least one B is included, or the case (3) where both of at least one A and at least one B are included.

Expressions “first”, “second”, “1st,” “2nd,” or the like, used in the disclosure may indicate various components regardless of sequence and/or importance of the components, will be used only in order to distinguish one component from the other components, and do not limit the corresponding components.

When it is described that an element (e.g., a first element) is referred to as being “(operatively or communicatively) coupled with/to” or “connected to” another element (e.g., a second element), it should be understood that it may be directly coupled with/to or connected to the other element, or they may be coupled with/to or connected to each other through an intervening element (e.g., a third element).

A term of a singular number may include its plural number unless explicitly indicated otherwise in the context. It is to be understood that a term “include”, “formed of”, or the like used in the application specifies the presence of features, numerals, steps, operations, components, parts, or combinations thereof, mentioned in the specification, and does not preclude the presence or addition of one or more other features, numerals, steps, operations, components, parts, or combinations thereof.

In the disclosure, a “module” or a “unit” may perform at least one function or operation, and be implemented by hardware or software or be implemented by a combination of hardware and software. In addition, a plurality of “modules” or a plurality of “units” may be integrated into at least one module and be implemented by at least one processor (not shown) except for a ‘module’ or a ‘unit’ that needs to be implemented by specific hardware.

Hereinafter, an embodiment of the present disclosure will be described in greater detail with reference to the accompanying drawings.

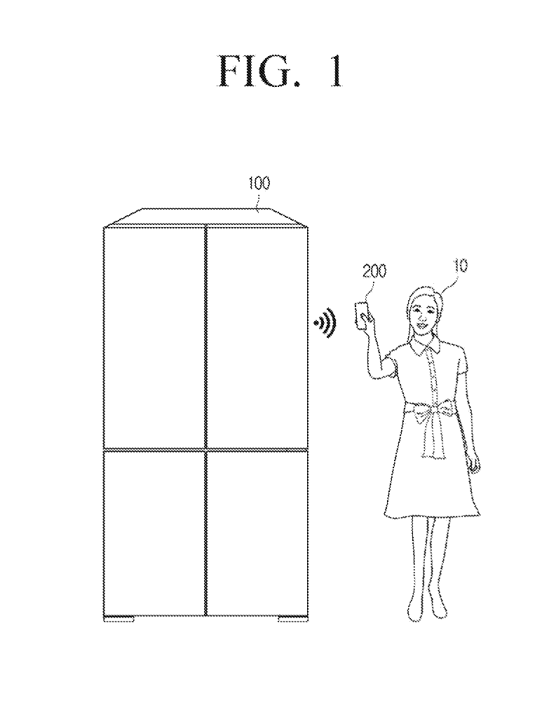

FIG. 1 is a view provided to explain operations of an electronic apparatus and a terminal apparatus according to at least one embodiment. In FIG. 1, the electronic apparatus 100 is illustrated as a refrigerator, and the terminal apparatus 200 is illustrated as a mobile phone; however, the electronic apparatus 100 and the terminal apparatus 200 may each be implemented as various types of apparatuses.

Specifically, the electronic apparatus 100 may be an apparatus that performs operations capable of generating noise or vibration. For example, in addition to a refrigerator as shown in FIG. 1, the electronic apparatus 100 may be implemented as various apparatuses such as a kimchi refrigerator, a washing machine, an air conditioner, an air purifier, a clothing storage cabinet, or a shoe storage cabinet.

The terminal apparatus 200 may be an apparatus capable of performing communication with the electronic apparatus 100. For example, the terminal apparatus 200 may be implemented not only as the mobile phone of FIG. 1, but also as various apparatuses such as a PC, a laptop PC, a tablet PC, a kiosk, a server apparatus, a smart watch, a TV, or a remote controller.

A user 10 may control operations of the electronic apparatus 100 using his or her terminal apparatus 200. Specifically, when the user 10 executes a specific application installed in the terminal apparatus 200, the terminal apparatus 200 displays a UI screen corresponding to execution of the application. The User Interface (UI) screen refers to a screen through which the user may view various types of information related to the electronic apparatus 100 or directly control operations of the electronic apparatus 100 by selecting various menus. The UI screen may also be referred to as an application execution screen, a management screen, or a control screen; however, in the present disclosure, it is referred to as a UI screen.

When unpleasant noise occurs in the electronic apparatus 100 or vibration is strongly felt, the user may select, on the UI screen, a menu for diagnosing noise and/or vibration. In general, noise may be caused by vibration generated by rotation of an object, and thus noise and vibration may be diagnosed together; however, the present disclosure is not limited thereto, and noise and vibration may be diagnosed separately. In the present disclosure, noise and/or vibration refers to one of noise and vibration or both noise and vibration.

When the user selects the corresponding menu, the terminal apparatus 200 may transmit a control signal for initiating a test mode to the electronic apparatus 100.

Upon receiving the control signal, the electronic apparatus 100 starts the test mode. The test mode is a mode for testing operation states of components built into the electronic apparatus 100. The test mode may also be referred to as a correction mode, a diagnosis mode, or a check mode; however, in the present disclosure, it is described as a test mode.

In the test mode, the electronic apparatus 100 turns off the entire apparatus and sequentially drives a plurality of components. Data regarding types of components driven in the test mode and a driving order thereof may be pre-stored in the electronic apparatus 100, or may be included in the control signal transmitted from the terminal apparatus 200 and delivered to the electronic apparatus 100.

As illustrated in FIG. 1, when the electronic apparatus 100 is implemented as a refrigerator, the refrigerator may include various components such as a compressor or a fan. While the electronic apparatus 100 sequentially drives, e.g., operates, the plurality of components, the user may directly test noise or vibration. For example, if noise or vibration generated while driving a compressor among components of the electronic apparatus 100 is unpleasant to the user, the user may select the compressor as a calibration target using the terminal apparatus 200.

When at least one component is selected as a calibration target, the electronic apparatus 100 re-drives the component while changing operation states thereof in various ways. The operation state, e.g., the plurality of operation states, may include various states such as an operating speed, an operating range, or an operating magnitude of the component. For example, when a compressor included in the refrigerator is selected as a calibration target, the electronic apparatus 100 may drive the compressor while varying an RPM of the compressor. While the operation state is changed, a magnitude of noise or vibration may also vary. The user may identify an operation state that the user perceives as optimal, while directly experiencing noise or vibration.

When the operation state is identified, the electronic apparatus 100 updates and stores setting information of the corresponding component as setting information corresponding to the identified operation state. In the above-described compressor example, when a specific RPM is selected, the electronic apparatus 100 may set the RPM of the compressor to the RPM selected by the user. When the user designates a plurality of noise and/or vibration sources rather than a single source, the electronic apparatus 100 sequentially drives the designated components while changing operation states thereof, and stores setting information corresponding to operation states selected by the user.

When the test mode is terminated, the electronic apparatus 100 drives all components based on the updated setting information. Among the plurality of components, components whose setting information has been updated (for example, the compressor) are driven according to the updated setting information (for example, RPM). Accordingly, noise or vibration generated by the corresponding components may be calibrated.

According to the above-described embodiments, the user may directly check and calibrate degrees of noise or vibration of each component. Since a perceived degree of noise or vibration is subjective, the user may optimize a noise and/or vibration state by setting an operation state suitable for the user.

Although FIG. 1 has been described based on a case in which the electronic apparatus 100 is controlled using the terminal apparatus 200, the above-described calibration operation may be performed by the electronic apparatus 100, or may be performed by a third external apparatus (for example, a server) other than the terminal apparatus 200 and the electronic apparatus 100. In addition, although FIG. 1 has described a case in which the user directly experiences noise or vibration and the terminal apparatus 200 changes setting information of each component accordingly, if a sensor capable of sensing noise or vibration is provided in the electronic apparatus 100, the electronic apparatus 100, the terminal apparatus 200, or a third external apparatus may automatically identify a component that causes noise or vibration based on sensing values of the sensor and calibrate setting information thereof to an optimal state.

Hereinafter, various embodiments as described above will be described in greater detail.

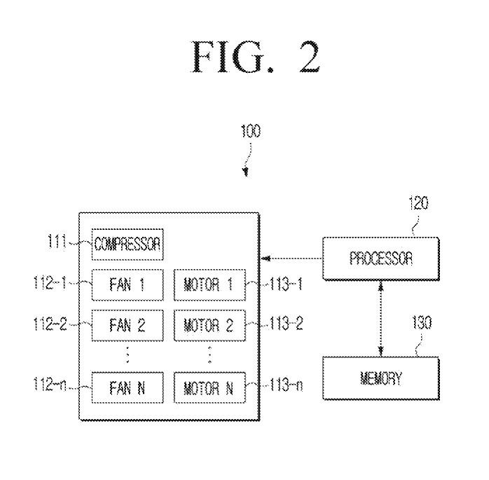

FIG. 2 is a block diagram illustrating configuration of the electronic apparatus 100 according to at least one embodiment. According to FIG. 2, the electronic apparatus 100 includes a plurality of components 111, 112-1 to 112-n, and 113-1 to 113-n, a processor 120, and memory 130. As described above, the electronic apparatus 100 may be implemented as various types of apparatuses; however, hereinafter, a case in which the electronic apparatus 100 is implemented as a refrigerator 100 as shown in FIG. 1 will be described.

In FIG. 1, a French door type refrigerator in which a single storage compartment is covered by a plurality of doors is illustrated; however, the present disclosure is not limited thereto, and the refrigerator may be implemented in various forms such as a side-by-side type, a bottom mounted freezer (BMF), a top mounted freezer (TMF), or a one-door refrigerator.

The refrigerator 100 may include both a refrigerating compartment and a freezing compartment, or may include only one of them. The refrigerator 100 includes various components such as a compressor 111, a plurality of fans 112-1 to 112-n, and a plurality of motors 113-1 to 113-n, as well as a processor 120 and memory 130 for controlling the same. In addition to the compressor 111, the refrigerator 100 may further include various components such as a condenser, a capillary tube, an evaporator, a sensor, a heater, etc.; however, since such components constitute a general configuration of the refrigerator 100, detailed illustration thereof is omitted.

The compressor 111 is configured to compress a refrigerant in a gaseous state into a high-temperature, high-pressure gas. The high-temperature, high-pressure gas compressed by the compressor 111 is transferred to the condenser. The condenser liquefies the high-temperature, high-pressure gas by allowing the gas to pass therethrough while releasing heat. Accordingly, the liquid converted to a low temperature is transferred to the capillary tube. The low-temperature, high-pressure liquid passes through the capillary tube, whereby the pressure thereof is reduced. The evaporator vaporizes the low-temperature, low-pressure liquid refrigerant that has passed through the capillary tube. In the process of vaporizing the liquid refrigerant in the evaporator, heat is absorbed from surrounding air, thereby generating cold air. The generated cold air is delivered to the refrigerating compartment and the freezing compartment of the refrigerator through air ducts by fans, respectively, and accordingly, temperatures of the refrigerating compartment and the freezing compartment are reduced.

Among these components, the compressor is driven by a compressor motor, and the compressor motor may operate in various RPM modes. As the RPM mode varies, the compressor motor rotates at different rotational speeds, and noise and vibration generated thereby may also vary.

In addition, the refrigerator 100 includes a plurality of fans 112-1 to 112-n and motors 113-1 to 113-n. The plurality of fans 112-1 to 112-n may include at least one fan for supplying and circulating cold air to the refrigerating compartment, at least one fan for supplying and circulating cold air to the freezing compartment, at least one fan for drawing in external air, at least one fan provided inside a machine room, and the like. Each of the motors 113-1 to 113-n is connected to each of the fans 112-1 to 112-n, and rotates the fans 112-1 to 112-n. Such motors 113-1 to 113-n also rotate at various rotational speeds according to setting information, and noise and vibration generated thereby may also be different.

The processor 120 is configured to control overall operations of the refrigerator 100. Specifically, when power of the refrigerator 100 is turned on, the processor 120 drives the compressor 111 to generate cold air, and drives each of the motors 113-1 to 113-n to rotate each of the fans 112-1 to 112-n, thereby supplying and circulating the cold air to the refrigerating compartment and the freezing compartment. The processor 120 may adjust a driving time of the compressor 111 according to an operation mode. Specifically, in a first operation mode, the processor 120 may drive the compressor 111 for about 50% within a preset time period, and may not drive the compressor during the remaining 50% of the time period. On the other hand, in a second operation mode, the processor 120 may drive the compressor 111 for about 70% within the preset time period, and may not drive the compressor during the remaining 30% of the time period. Such operation modes and numerical ranges thereof are merely examples, and may be variously modified. The processor 120 may identify an internal temperature of the refrigerating compartment, an internal temperature of the freezing compartment, and the like based on sensing values of sensors provided in the refrigerator 100, and may automatically change operation states of respective components according to changes in the identified temperatures. Alternatively, the processor 120 may change operation states of the respective components according to a set temperature that is set by a user or an operation mode selected by the user (for example, a power-saving mode, a rapid cooling mode, a rapid freezing mode, a freshness mode, etc.).

The processor 120 may be implemented as a digital signal processor (DSP), a microprocessor, a graphics processing unit (GPU), an artificial intelligence (AI) processor, a neural processing unit (NPU), or the like. However, the present disclosure is not limited thereto, and the processor 120 may include one or more of, or be defined as, a central processing unit (CPU), a micro controller unit (MCU), a micro processing unit (MPU), a controller, an application processor (AP), a communication processor (CP), or an ARM processor. In addition, the processor 120 may be implemented as a system on chip (SoC) or large scale integration (LSI) in which a processing algorithm is embedded, or may be implemented in the form of an application specific integrated circuit (ASIC) or a field programmable gate array (FPGA).

The processor 120 may control operations of the refrigerator 100 by executing an artificial intelligence model. In this case, the processor 120 may be implemented through a combination of software and a general-purpose processor such as a CPU, an AP, or a digital signal processor (DSP), a graphics-dedicated processor such as a GPU or a vision processing unit (VPU), or an artificial-intelligence-dedicated processor such as an NPU. The processor 120 may be designed with a hardware structure specialized for processing a specific artificial intelligence model. For example, the processor 120 may be designed as a hardware chip such as an ASIC or an FPGA specialized for processing a specific artificial intelligence model.

The processor 120 may be implemented to include memory for implementing various embodiments of the present disclosure, or may be implemented to include a memory processing function for using external memory. Although FIG. 2 illustrates one processor 120, the processor 120 may be implemented as a plurality of processors.

The memory 130 is configured to store programs, instructions, data, and the like required for operations of the refrigerator 100. The memory 130 may store setting information for operations of respective components of the refrigerator 100. The setting information for operation may include values for setting operation states of the respective components. The setting information may include various information such as setting values differently set for each operation mode, default setting values, current operation mode information, and previous operation mode information.

The memory 130 may be implemented as at least one of various types of memories, including volatile memory, such as dynamic random access memory (DRAM), static random access memory (SRAM), or synchronous dynamic random access memory (SDRAM), or non-volatile memory, such as one-time programmable read-only memory (OTPROM), programmable read-only memory (PROM), erasable programmable read-only memory (EPROM), electrically erasable programmable read-only memory (EEPROM), mask read-only memory (mask ROM), flash read-only memory (flash ROM), flash memory such as NAND flash memory or NOR flash memory, a hard disk drive, or a solid-state drive (SSD).

Although FIG. 2 illustrates one memory 130, the memory 130 may be implemented to include a plurality of memories configured to store different types of data or to respectively store data generated at different stages, and at least one of the memories may be implemented as a single chip integrated with the processor 120.

When a preset event occurs, the processor 120 may execute a test mode for diagnosing noise and/or vibration of the refrigerator 100. The events may include various events such as an event in which a preset time period arrives, an event in which a user inputs a control command for starting the test mode through the refrigerator 100 or the terminal apparatus 200, an event in which a control signal for starting the test mode is received from an external server, an event in which a level of noise and/or vibration sensed by the refrigerator 100 itself or a peripheral apparatus exceeds a preset threshold value, an event in which the refrigerator 100 is turned on, and an event in which a turn-off command for the refrigerator 100 is input.

When the test mode is executed, the processor 120 stops operations of all components, and sequentially drives a plurality of preset components among the components.

In addition to the compressor 111, the plurality of fans 112-1 to 112-n, and the plurality of motors 113-1 to 113-n illustrated in FIG. 2, the refrigerator 100 may further include various mechanical components, circuit components, sensors, and the like. However, components capable of causing noise or vibration mostly include rotating bodies or components connected to rotating bodies. Accordingly, in diagnosing noise and/or vibration, it is not necessary to drive all components. In consideration of this, a manufacturer of the refrigerator 100 or other related entities may preselect components related to noise or vibration, and may store information on the selected components in advance in the memory 130. When the test mode is executed, the processor 120 sequentially drives a plurality of selected components based on the information stored in the memory 130. Types of components driven in the test mode may be updated at any time or periodically. Alternatively, when desired by a user or a service engineer, operation may be performed such that all components are sequentially driven.

When a plurality of components are sequentially driven according to the test mode, noise and/or vibration generated by a single component may be easily measured. The processor 120 may select at least one of the plurality of components as a calibration target based on noise and/or vibration states of the respective components. Specifically, a user may select a calibration target through a UI screen provided in the refrigerator 100 or the terminal apparatus 200 while directly experiencing noise and/or vibration. Alternatively, when at least one sensor capable of measuring noise and/or vibration is provided in the refrigerator 100, a calibration target may be selected based on sensing values of the sensor by the refrigerator 100, the terminal apparatus 200, or a third external apparatus (for example, a server apparatus). Each of these embodiments will be described again in detail in a later part.

According to the above-described embodiments, the processor 120 may sequentially drive a plurality of components one by one. However, the present disclosure is not limited thereto, and according to another embodiment, after sequentially driving the plurality of components one by one, the processor 120 may combine a plurality of components and drive the combined components together. For example, when a compressor and four fans and motors are test targets, the processor 120 may sequentially perform an operation of driving one fan and motor together with the compressor, and then driving another fan and motor together with the compressor. According to such an embodiment, not only noise and/or vibration generated independently by a single component, but also howling noise generated according to a combination of multiple components may be calibrated.

When at least one component is selected as a calibration target, the processor 120 drives the selected component while sequentially changing an operation state of the selected component. For example, when fan 1112-1 and motor 1113-1 for driving the fan 1112-1 are selected as calibration targets, the processor 120 may drive the motor 1113-1 while sequentially changing a rotational speed of the motor 1113-1 from a minimum speed to a maximum speed range. Noise and/or vibration also changes according to a change in the rotational speed. When a specific operation state is selected among operation states while the operation state is being changed, the processor 120 stores setting information corresponding to the selected operation state in the memory 130. When previous setting information of the corresponding component is stored in the memory 130, the processor 120 may change and store the setting information to the setting information corresponding to the selected operation state, or may additionally store new setting information separately from the previous setting information.

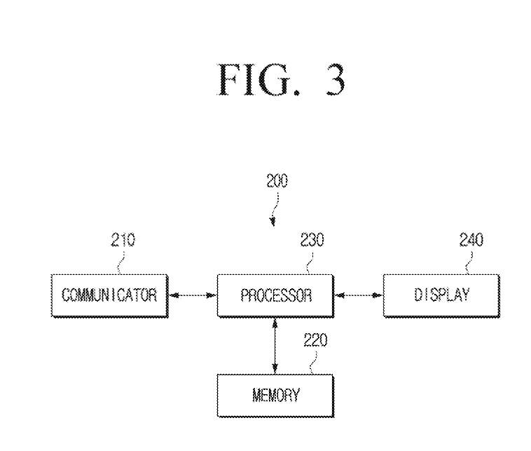

FIG. 3 is a block diagram illustrating configuration of a terminal apparatus according to at least one embodiment. According to FIG. 3, the terminal apparatus 200 includes a communicator 210, memory 220, a processor 230, and a display 240. As described with reference to FIG. 1, the terminal apparatus 200 may be implemented as various types of devices that are usable by a user.

The communicator 210 is configured to perform communication with various external apparatuses. Specifically, the communicator 210 may perform communication with the electronic apparatus 100 of FIG. 1, and may also perform communication with an external server apparatus or other electronic apparatuses.

The communicator 210 may include at least one wireless communication module and at least one wired communication module. Each communication module may be implemented in the form of at least one hardware chip. For example, the wireless communication module may include at least one of a Wi-Fi module, a Bluetooth module, an infrared communication module, or other communication modules. In addition, the communicator 210 may include at least one communication chip configured to perform communication in accordance with various wireless communication standards, such as Zigbee, third generation (3G), third generation partnership project (3GPP), long term evolution (LTE), LTE advanced (LTE-A), fourth generation (4G), and fifth generation (5G). The wired communication module may include, for example, at least one of a local area network (LAN) module, an Ethernet module, a pair cable, a coaxial cable, an optical fiber cable, or an ultra-wideband (UWB) module.

In addition, the communicator 210 may further include at least one wired input/output interface, such as a high-definition multimedia interface (HDMI), mobile high-definition link (MHL), universal serial bus (USB), USB Type-C, display port (DP), Thunderbolt, video graphics array (VGA) port, RGB port, D-subminiature (D-SUB), or digital visual interface (DVI).

The memory 220 is configured to store various programs, instructions, and data required for operations of the terminal apparatus 200. For example, the memory 220 may store applications for controlling operations of the electronic apparatus 100.

The processor 230 may perform various operations based on various programs, instructions, and data stored in the memory 220. The processor 230 may control the display 240 to display identifiers (for example, icons) for executing various applications stored in the memory 220. When one of the displayed identifiers is selected, the processor 230 may execute an application corresponding to the selected identifier, and control the display 240 to display an execution screen thereof.

Detailed examples of the memory 220 and the processor 230 are similar to those described with reference to FIG. 2, and thus redundant descriptions are omitted.

The display 240 is configured to display various screens under the control of the processor 230. The display 240 may display execution screens of various applications executed by the processor 230. The display 240 may be implemented as various types of displays, such as a liquid crystal display (LCD), an organic light-emitting diode (OLED) display, liquid crystal on silicon (LCoS), digital light processing (DLP), a quantum dot (QD) display panel, quantum dot light-emitting diodes (QLED), micro light-emitting diodes (μLED), or a mini LED display. Alternatively, the display 240 may be implemented as a touch screen combined with a touch sensor, a flexible display, a rollable display, a three-dimensional (3D) display, or a display in which a plurality of display modules are physically connected.

When an application for controlling operations of an electronic apparatus is selected by a user, the processor 230 executes the application. In accordance with execution of the application, the processor 230 configures a user interface (UI) screen corresponding to the electronic apparatus, and controls the display 240 to display the configured UI screen. When the corresponding application is an integrated application capable of selectively controlling a plurality of electronic apparatuses, items of controllable electronic apparatuses may be displayed on the UI screen.

In addition, in accordance with execution of the application, the processor 230 may control the communicator 210 to establish a communication session with the electronic apparatus 100. However, the present disclosure is not limited thereto, and the processor 230 may control the communicator 210 to maintain a communication session with the electronic apparatus 100 at all times even before execution of the application. A communication session establishment method may be performed in various sequences depending on a communication scheme between the electronic apparatus 100 and the terminal apparatus 200, and since such methods are well known in various communication standards, detailed descriptions thereof are omitted.

When a user selects a menu on the UI screen, the processor 230 transmits a control signal corresponding to the selected menu to the electronic apparatus 100 through the communicator 210. The control signal may include an identification code for specifying the corresponding electronic apparatus 100 among a plurality of electronic apparatuses, a control code for specifying an operation to be performed by the electronic apparatus 100 and the like. The control signal may be generated in various formats depending on a communication scheme between the electronic apparatus 100 and the terminal apparatus 200.

For example, when a user selects a menu for diagnosing noise and/or vibration of the electronic apparatus 100 on the UI screen, the processor 230 controls the communicator 210 to transmit a control signal for initiating a test mode to the electronic apparatus 100. When the electronic apparatus 100 executes the test mode according to the control signal and sequentially drives a plurality of components included in the electronic apparatus 100, the processor 230 may provide the driving process to the user through the UI screen.

The user may designate at least one component as a calibration target through the UI screen. When the calibration target is designated, the processor 230 may control the communicator 210 to transmit a control signal for driving the designated component to the electronic apparatus 100. In this case, the processor 230 may transmit a control signal for driving the designated component while sequentially changing operation states of the designated component, or a control signal for driving the designated component for a preset time.

When a specific operation state among operation states of the designated component is selected through the UI screen, the processor 230 may control the communicator 210 to transmit setting information corresponding to the selected operation state to the electronic apparatus 100. Accordingly, when the test mode is terminated, the electronic apparatus 100 may drive all components based on the changed setting information.

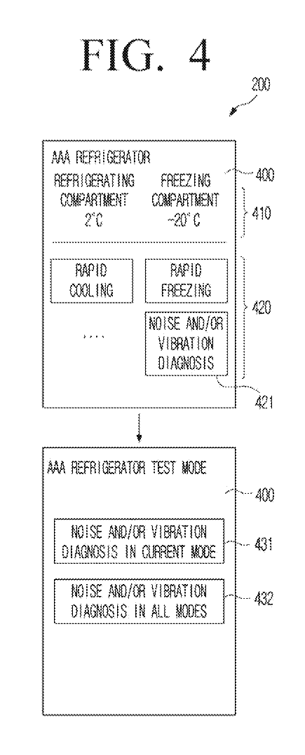

FIG. 4 is a view illustrating an example of a UI screen provided by the terminal apparatus 200. According to FIG. 4, the terminal apparatus 200 may display, on the display 240, a user interface (UI) screen 400 for controlling an AAA refrigerator. The UI screen 400 may include various messages 410 indicating a state of the refrigerator, and various menus 420 selectable by a user.

When the user selects, on the UI screen 400, a menu 421 for diagnosing noise and/or vibration of the electronic apparatus 100, the processor 230 changes the UI screen 400 to display menus 431 and 432 for confirming whether to diagnose noise and/or vibration with respect to a current refrigerator mode or with respect to all refrigerator modes. When the user feels noise or vibration while currently using the refrigerator, the user may select a first menu 431. On the other hand, when the user does not currently feel noise or vibration but desires to perform an overall diagnosis, the user may select a second menu 432.

When the user selects the first menu 431, the processor 230 controls the communicator 210 to transmit a control signal for initiating a first test mode for calibrating a current noise and/or vibration state to the electronic apparatus 100.

When the user selects the second menu 432, the processor 230 controls the communicator 210 to transmit a control signal for initiating a second test mode for diagnosing and calibrating causes of noise and/or vibration across all refrigerator modes to the electronic apparatus 100.

Although FIG. 4 illustrates that the first test mode and the second test mode are distinguished and selectable by the user, this corresponds to one embodiment. In another embodiment, only a single test mode may be supported without distinguishing the first test mode and the second test mode. In other words, when the user selects the menu 421 for diagnosing noise and/or vibration on the UI screen 400, the processor 230 may control the communicator 210 to immediately transmit a control signal for initiating the test mode to the electronic apparatus 100.

When the electronic apparatus 100 receives the control signal, the electronic apparatus 100 may execute the test mode according to the control signal and sequentially drive a plurality of components included in the electronic apparatus 100. When a control signal for executing the first test mode is received, the processor 120 of the electronic apparatus 100 may control each of the plurality of components to sequentially operate in an operation state corresponding to latest setting information, e.g., updated setting information, stored in the memory 130 of the electronic apparatus 100.

On the other hand, when a control signal for executing the second test mode is received, the processor 120 of the electronic apparatus 100 may control each of the plurality of components to sequentially operate in an operation state corresponding to default setting information stored in the memory 130 of the electronic apparatus 100.

The processor 230 of the terminal apparatus 200 may display an operation state of the electronic apparatus 100 within the UI screen 400.

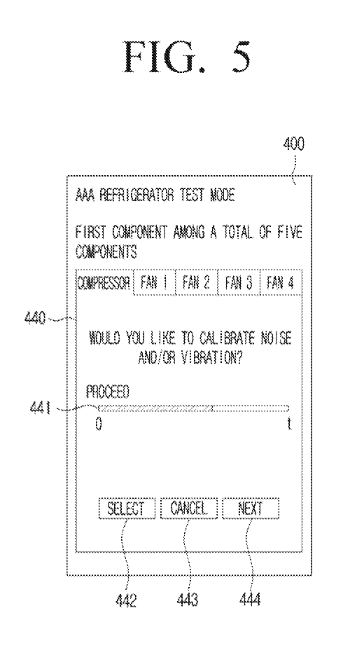

According to FIG. 5, within the UI screen 400, a message 440 indicating that a total of five components (a compressor, fan 1, fan 2, fan 3, and fan 4) among components of the electronic apparatus 100 are sequentially driven under the test mode and that one of the components, namely the compressor 111, is currently being driven, may be displayed. The UI screen 400 may display various menus, such as a graph 441 indicating a driving level of the currently driven compressor, a menu 442 for selecting the compressor as a calibration target, a menu 443 for canceling a selection, and a menu 444 for switching driving to a next component. The processor 230 may control the communicator 210 to transmit various control signals to the electronic apparatus 100 according to a user’s menu selection.

In the first test mode, the processor 230 sequentially drives each component based on current setting information. For example, when a revolutions per minute (RPM) of the compressor is currently set to 1700, the processor 230 drives the compressor 111 at 1700 RPM for a preset time. In this case, the graph 441 may indicate a time during which the compressor 111 is driven. For example, when the compressor 111 is driven from time 0 to time t, the processor 230 may change a display of the graph 441 according to the driving time.

When the user selects the selection menu 442 while the compressor 111 is being driven, the processor 230 may select the compressor 111 as a calibration target. Once selection of the compressor is determined, the processor 230 terminates driving of the compressor 111 and drives a next component, fan 1, for a preset time based on a current setting value, while confirming whether the user selects the selection menu. When the user selects the selection menu 442 again while fan 1 is being driven, the processor 230 may select not only the compressor 111 but also fan 1 together as calibration targets.

In the second test mode, the processor 230 sequentially drives each component based on overall operation modes. Specifically, when changing an RPM of the compressor, the processor 230 sequentially changes and drives the compressor RPM from a minimum RPM to a maximum RPM t, and may simultaneously change a display state of the graph 441 within a range from 0 to t such that the user can intuitively recognize a change state. Although FIG. 5 illustrates the minimum RPM as 0, the present disclosure is not limited thereto, and the minimum RPM and the maximum RPM may be set to various values. When the user selects the selection menu 442 during RPM change, the processor 230 may select the compressor 111 as a calibration target. Once selection of the compressor 111 is determined, the processor 230 terminates driving of the compressor 111 and sequentially drives a next component, fan 1, from a minimum setting value (for example, a minimum RPM) to a maximum setting value (for example, a maximum RPM), while confirming whether the user selects the selection menu. As described above, the processor 230 may change a display of the UI screen 400 in association with whether components of the electronic apparatus 100 are driven and their operation states, thereby supporting the user to directly select calibration targets.

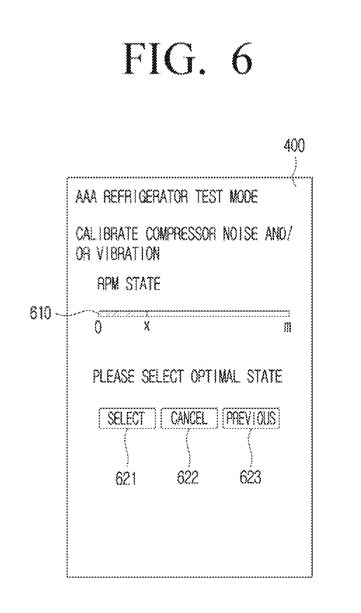

FIG. 6 illustrates a UI screen after selection of a calibration target is completed. According to FIG. 6, the UI screen 400 may include a graph 610 indicating a process in which the compressor 111 is driven while changing a revolutions per minute (RPM) value from a minimum value to a maximum value m, a menu 621 for allowing a user to select a specific operation state, a menu 622 for canceling a selection, a menu 623 for returning to a previous state, that is, a calibration target selection screen, and the like.

The processor 230 changes a display state of the graph 610 in correspondence with an RPM change state of the compressor 111. When the user feels that a noise and/or vibration state is satisfactory at a specific time point, the user may select the selection menu 621. The processor 230 may set an RPM at a time point at which the selection menu 621 is selected as an RPM of the compressor 111, and store the same in the memory 220.

Meanwhile, when the user selects the cancel menu 622 after selection, the processor 230 may cancel the selection state and drive the compressor 111 again. In this case, the processor 230 may drive the compressor 111 starting immediately from an RPM at a time point selected by the user, or, according to an embodiment, may drive the compressor 111 again starting from a minimum RPM.

Operations such as driving of each component and storing of setting values may be performed by the electronic apparatus 100 in response to control signals transmitted by the processor 230 of the terminal apparatus 200 according to a user’s menu selection. However, the present disclosure is not limited thereto, and the electronic apparatus 100 may automatically drive each component according to execution of a test mode. In this case, when diagnosis of all components to be tested is completed and setting information for at least one component selected as a calibration target is stored, the processor 230 may transmit, to the electronic apparatus 100 through the communicator 210, a control signal including a control code for terminating the test mode, information on the calibration target, and setting information for the calibration target, such that setting information of the electronic apparatus 100 is collectively changed.

In the above description, a method in which a user directly calibrates noise and/or vibration of the electronic apparatus 100 using the terminal apparatus 200 has been described; however, when the electronic apparatus 100 includes a display, the user may directly calibrate noise and/or vibration on the electronic apparatus 100.

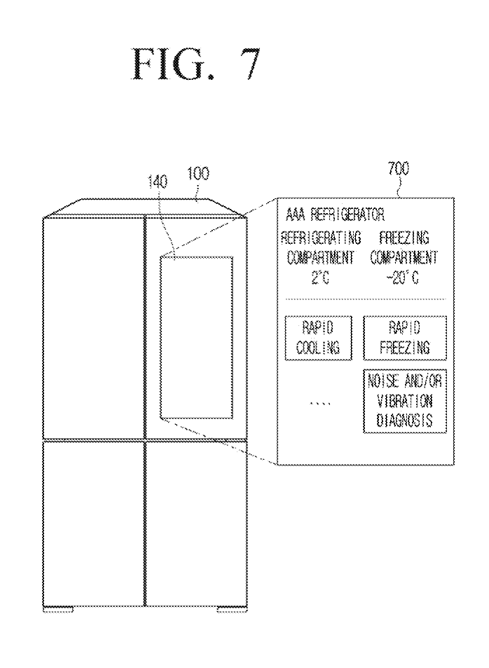

FIG. 7 illustrates the electronic apparatus 100 including a display 140. According to FIG. 7, the processor 120 may control the display 140 to display various screens. FIG. 7 illustrates a state in which a UI screen 700 similar to a first UI screen of FIG. 4 is displayed. The user may select various menus on the UI screen 700.

When the user selects a menu for diagnosing noise and/or vibration through the UI screen 700, the processor 120 may recognize that a first control command for initiating a test mode has been input. The processor 120 executes the test mode according to the first control command and sequentially drives a plurality of components. The processor 120 controls the display 140 to display information on a component currently being driven on the UI screen 700. Since a specific configuration of the UI screen 700 may be similar to that of FIG. 5, redundant descriptions are omitted.

The user may select at least one component among a plurality of components as a calibration target on the UI screen. When the processor 120 recognizes that a second control command for selecting at least one component as a calibration target has been input, the processor 120 drives the component selected as a calibration target while sequentially changing operation states thereof. The processor 120 may control the display 140 to display information on the operation states of the selected component on the UI screen 700. Since a specific configuration of the UI screen 700 may be similar to that of FIG. 6, redundant descriptions are omitted.

When the user selects a menu for specifying one operation state among operation states of a component on the UI screen, the processor 120 may recognize that a third control command for setting an operation state has been input. The processor 120 stores setting information for the operation state specified by the third control command in the memory 130. Since user selection through the UI screen has been described in detail with reference to FIGS. 4 to 6, further descriptions are omitted.

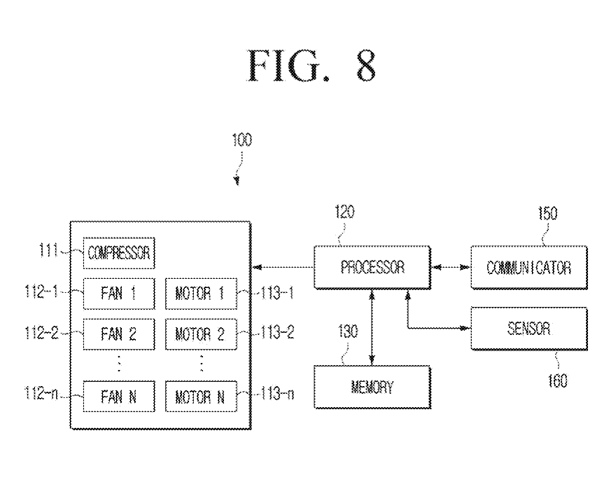

In the above description, embodiments in which a user directly calibrates noise and/or vibration while sensing noise and/or vibration through the electronic apparatus 100 or the terminal apparatus 200 have been described. However, the present disclosure is not limited thereto. For example, when the electronic apparatus 100 includes a sensor capable of sensing noise and/or vibration, calibration may be automatically performed using the sensor. FIG. 8 illustrates such various embodiments.

According to FIG. 8, the electronic apparatus 100 may further include a communicator 150 and a sensor 160 in addition to various components such as a compressor 111, a plurality of fans 112-1 to 112-n, and a plurality of motors113-1 to 113-n, the processor 120, and the memory 130. Although FIG. 8 illustrates one sensor 160, the sensor 160 may be implemented as a plurality of sensors.

At least one of the sensors 160 may be implemented as a microphone. The microphone is configured to receive various audio signals. The microphone may include a diaphragm that vibrates due to various noise inside or outside the electronic apparatus 100 and a circuit unit that outputs an electrical signal that varies according to vibration of the diaphragm. Accordingly, the microphone may provide the processor 120 with an electrical signal having a magnitude or frequency corresponding to noise. The processor 120 may measure an intensity of noise based on an output signal of the microphone.

Alternatively, the sensor 160 may include a vibration detection sensor. The vibration detection sensor may be disposed at various positions, such as an inner surface or an outer surface of the refrigerator, one surface of a component, or an installation portion where the corresponding component is installed. The vibration detection sensor may include a piezoelectric element. The piezoelectric element is an element for converting vibration into an electrical signal and outputting the electrical signal. The processor 120 may measure an intensity of vibration based on a magnitude of the electrical signal output from the vibration detection sensor..

The communicator 150 is configured to perform communication with various external apparatuses including the terminal apparatus 200. Since specific examples of the communicator 150 are similar to those described with reference to the terminal apparatus 200 of FIG. 3, redundant descriptions are omitted.

Although FIG. 8 illustrates an embodiment including both the sensor 160 and the communicator 150, the present disclosure is not limited thereto, and according to various embodiments, only one of the sensor 160 or the communicator 150 may be included.

First, an embodiment including the sensor 160 will be described.

When a test mode is executed, the processor 120 sequentially drives a plurality of components. The test mode may be initiated according to a control command input through the display 140, buttons, or a remote controller provided in the electronic apparatus 100 itself, or may be initiated according to a control signal received from the terminal apparatus 200 or another external apparatus.

While each component is sequentially driven, the processor 120 identifies a noise and/or vibration state of each component based on sensing values sensed by at least one sensor 160. As described above, when both a microphone and a vibration detection sensor are included, both noise and vibration may be identified, and when only one of the sensors is included, only one of noise or vibration may be identified.

The processor 120 may select at least one component among the plurality of components as a calibration target based on identification results for each component. Specifically, the processor 120 may check information on an allowable range for noise or vibration for each component from the memory 130. The allowable range for noise or vibration for each component may be variably set according to an operation mode. For example, an allowable range for a rapid cooling mode or a rapid freezing mode may be set wider or higher than that for a power saving mode or a low-noise mode. When the processor 120 recognizes that noise or vibration exceeding an allowable range occurs while driving one component, the processor 120 may select the corresponding component as a calibration target. The processor 120 may select a plurality of calibration targets.

When a calibration target is selected, the processor 120 controls each component to be driven while sequentially changing an operation state of a component selected as the calibration target. The processor 120 controls at least one sensor 160 to detect noise and/or vibration while each component is being driven. The processor 120 identifies a noise and/or vibration state of the selected component for each operation state based on sensing values of the sensor 160. The processor 120 selects a specific operation state among operation states of the component based on identification results identified for each operation state. Specifically, when a refrigerator mode is a rapid cooling mode, the processor 120 may select an operation state at which noise and/or vibration within an allowable range set for the rapid cooling mode has occurred. The processor 120 stores setting information corresponding to the selected specific operation state in the memory 130.

Meanwhile, in the case of an embodiment including the communicator 150, the processor 120 may receive or transmit various control signals and data from or to the terminal apparatus 200 or an external apparatus through the communicator 150.

Specifically, when a first control signal for initiating a test mode is received through the communicator 150, the processor 120 executes the test mode and sequentially drives a plurality of components according to setting information stored in the memory. In this state, when a second control signal for selecting at least one component as a calibration target is received through the communicator 150, the processor 120 drives the selected component while sequentially changing operation states of the component selected as the calibration target.

Subsequently, when a third control signal for selecting a specific operation state among operation states of a component is received through the communicator 150, the processor 120 stores setting information corresponding to the specific operation state in the memory 130.

When the test mode is terminated, the processor 120 drives all components according to setting information stored in the memory 130.

Meanwhile, as illustrated in FIG. 8, in the case of an embodiment including both the communicator 150 and the sensor 160, the processor 120 may transmit a sensing result of the sensor 160 to a terminal apparatus or an external apparatus through the communicator 150, and may perform a test according to control of the terminal apparatus or the external apparatus. Here, the external apparatus may mean a server apparatus other than the terminal apparatus. Hereinafter, for convenience of description, apparatuses other than the electronic apparatus will be collectively referred to as external apparatuses.

Specifically, when a first control signal for initiating a test mode is received from an external apparatus through the communicator 150, the processor 120 executes the test mode and sequentially drives a plurality of components. While each component is driven, the processor 120 identifies noise and/or vibration states of the plurality of components based on sensing values sensed by at least one sensor 160 and transmits identification results to the external apparatus through the communicator 150. In another embodiment, the processor 120 may transmit sensing values themselves to the external apparatus, and the external apparatus may identify noise and/or vibration states based on the sensing values.

When a second control signal for selecting at least one component as a calibration target is received through the communicator 150, the processor 120 drives the selected component while sequentially changing operation states of the component selected as the calibration target. The processor 120 may identify a noise and/or vibration state of the selected component for each operation state based on sensing values sensed by at least one sensor 160 during driving of the selected component while sequentially changing the operation states of the selected component, and may transmit identification results to an external apparatus through the communicator 150. In this case as well, as described above, the configuration may be modified such that the sensing values themselves are transmitted to the external apparatus.

When a third control signal for selecting a specific operation state among operation states of a component is received through the communicator 150, the processor 120 stores setting information corresponding to the specific operation state in the memory 130.

Although the above description has been made based on a case in which operation states are diagnosed in overall modes, the present disclosure is not limited thereto, and as described with reference to FIGS. 4 and 5, a state of a component may be diagnosed based on a current refrigerator mode.

As described above, according to various embodiments of the present disclosure, noise and/or vibration may be detected and calibrated by diagnosing components of the electronic apparatus 100 in various manners.

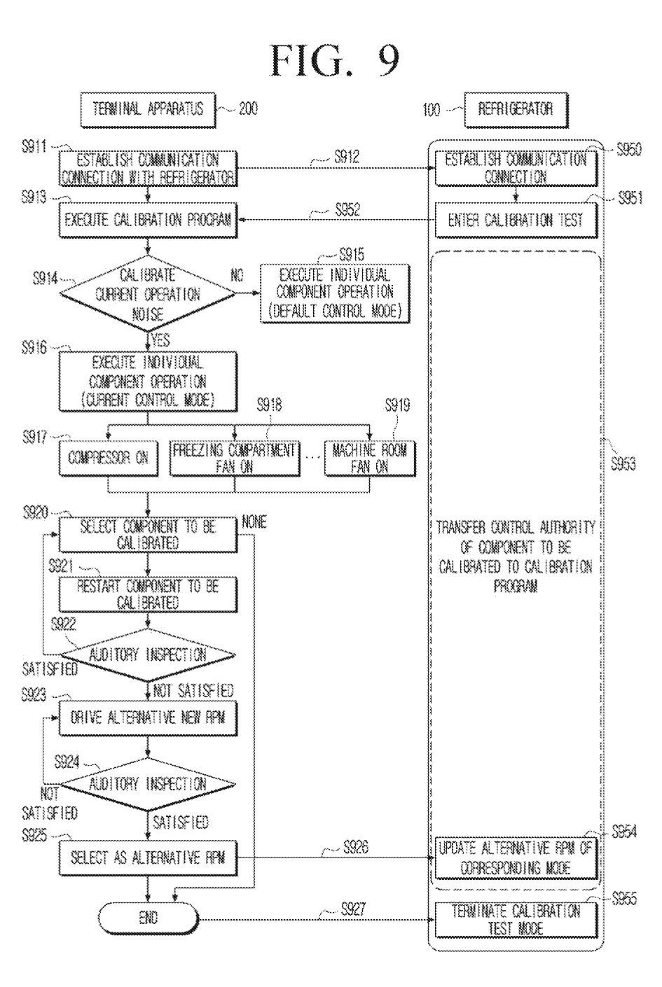

FIG. 9 is a timing view provided to specifically explain operations of the electronic apparatus 100 and the terminal apparatus 200 with reference to an embodiment using the terminal apparatus 200 as in FIG. 1.

According to FIG. 9, the terminal apparatus 200 and the refrigerator 100 establish communication with each other (S911, S950). When communication is established, the terminal apparatus 200 transmits a control signal for requesting entry into a test mode and current operation control information of the refrigerator (S912).

The refrigerator 100 enters the test mode according to the control signal (S951), and transmits operation information (that is, setting information) for each component requested by the terminal apparatus 200 (S952).

The terminal apparatus 200 may execute a calibration program based on the received information (S913). While switching to the test mode, the refrigerator 100 may transfer control authority for a calibration target to the terminal apparatus 200 (S953). Specifically, the refrigerator 100 may transfer control authority to a calibration program executed by the terminal apparatus 200.

The terminal apparatus 200 receive confirmation from a user through a UI screen as to whether to calibrate operation noise in a current operation mode. Since a specific example of the UI screen has been described with reference to FIG. 4, a duplicate description thereof will be omitted. When the user desires to calibrate current operation noise and/or vibration, the terminal apparatus 200 controls the refrigerator 100 to execute individual operation for each component. Specifically, the terminal apparatus 200 may control the refrigerator 100 to drive each component while maintaining RPMs of components that were operating at a time when communication with the refrigerator 100 was established.

On the other hand, when the user desires to calibrate operation noise and/or vibration in overall modes, the terminal apparatus 200 controls the refrigerator 100 to execute individual operation for each component in a default control mode (S914). The default control mode refers to a mode in which each component is driven according to default setting information.

When a component to be calibrated, that is, a calibration target, is selected (S920) while individual operation for each component (S917, S918, and S919) is being performed or after the individual operation is completed, the terminal apparatus 200 controls the refrigerator 200 to re-drive the calibration target (S921). For example, when a compressor is selected and an RPM set for the compressor in a current refrigerator mode is 2000, the terminal apparatus 200 re-drives the compressor at 2000 RPM.

The user may directly experience noise and/or vibration while re-driving is performed (S922). As a result of the experience, when noise and/or vibration caused by the compressor is still unsatisfactory, the terminal apparatus 200 may re-drive the compressor while changing a currently set RPM to a neighboring RPM that replaces the currently set RPM (S923). The user may again experience noise and/or vibration in a re-driving state (S924).

When a re-driving result is unsatisfactory, the terminal apparatus 200 repeatedly performs a process of re-driving while changing an operation state (that is, RPM). On the other hand, when a re-driving result is satisfactory, the terminal apparatus 200 may specify the operation state, and transmit setting information corresponding to the operation state to the refrigerator 100 (S925, S926). For example, when an RPM of a compressor at 2100 is an optimal state, a control signal for changing the RPM of the compressor to 2100 may be transmitted to the refrigerator 100.

The refrigerator 100 may store setting information of a component in a corresponding refrigerator mode according to the control signal (S954). In other words, the refrigerator 100 may store the RPM of the compressor by replacing the RPM with 2100.

When the test is completed, the terminal apparatus 200 transmits an end signal (S927), and the refrigerator 100 terminates a test mode according to the end signal (S955).

When the test mode is terminated, the refrigerator 100 drives all components again and returns to a normal mode.

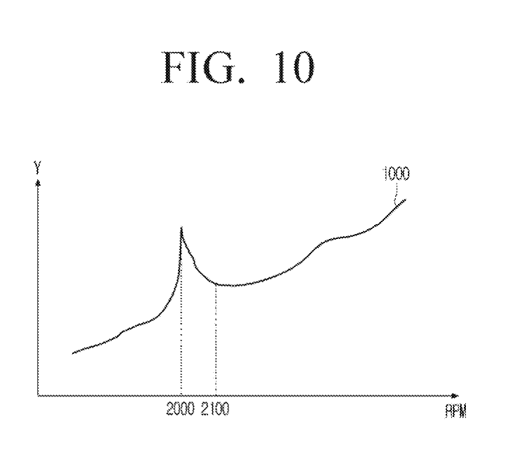

FIG. 10 is a view illustrating a method of changing setting information of a specific component. In FIG. 10, a horizontal axis may represent an RPM of a compressor. A vertical axis Y may represent various values that may serve as indicators of noise and/or vibration, such as a noise level (dB, dBA), loudness, sharpness, roughness, fluctuation strength, vibration magnitude, customer listening discomfort, and the like.

In general, even when a component of the electronic apparatus 100 is driven independently, noise and/or vibration may increase at a specific state due to resonance. FIG. 10 illustrates that noise and/or vibration changes relatively linearly as the RPM increases, and is irregularly measured to be large at 2000 RPM. In such a case, noise or vibration of a level irritating to a user may occur. FIG. 10 illustrates changing 2000 RPM to 2100 RPM. The processor 120 of the refrigerator 100 adjusts setting information for each component stored in the memory 130 to control each component to be driven in a state in which noise and/or vibration is minimized. Specifically, the processor 120 may ultimately adjust a rotation speed or an operation speed of the corresponding component by performing operations such as adjusting an RPM value transmitted to the corresponding component based on the changed RPM information, adjusting a magnitude of a voltage or a current applied to the corresponding component, or adjusting a duty of a pulse signal applied to the corresponding component.

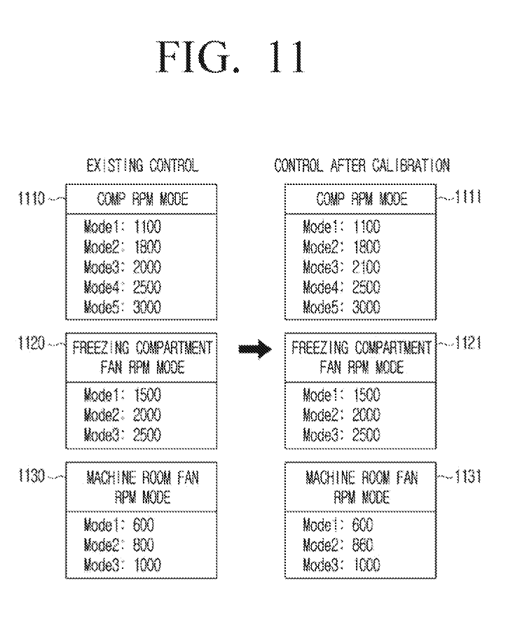

FIG. 11 illustrates an example in which setting information is changed for a plurality of components. FIG. 11 illustrates RPM modes of a compressor 1110, a freezer fan 1120, and a machine room fan 1130 before calibration, and RPM modes of the compressor 1111, the freezer fan 1121, and the machine room fan 1131 after calibration.

According to FIG. 11, it is illustrated that the RPM in mode 3 among operation modes of the compressor is changed from 2000 to 2100, and the RPM in mode 2 among operation modes of the machine room fan is changed from 800 to 860. In FIG. 11, operation modes of the respective components are distinguished based on RPM. Therefore, depending on user settings or a refrigerator mode, the components may be set in combination, such as compressor mode 3, freezer compartment fan mode 2, and machine room fan mode 2.

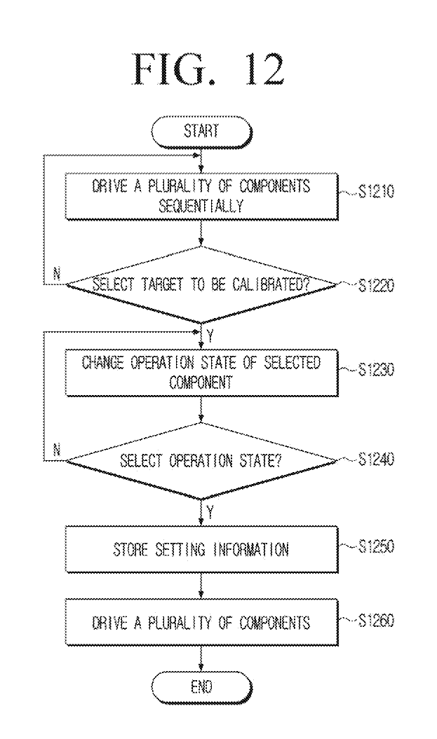

FIG. 12 is a flowchart provided to explain a noise and/or vibration calibration method according to various embodiments of the present disclosure.

According to FIG. 12, the electronic apparatus sequentially drives a plurality of components (S1210). When a calibration target is selected among driven components (S1220), the electronic apparatus re-drives the selected component while maintaining a previous operation state or drives the selected component while sequentially changing operation states (S1230). Such operations may vary depending on whether a first test mode or a second test mode is executed according to user selection as described with reference to FIG. 4, but this is only one embodiment, and in another embodiment, components may be driven while sequentially changing operation states without user selection.

When one operation state is selected (S1240), the electronic apparatus stores selected setting information (S1250).

When all calibrations are completed, the electronic apparatus drives each component built in the electronic apparatus based on the finally stored setting information (S1260).

The noise and/or vibration calibration method described with reference to FIG. 12 may be performed by an electronic apparatus including configurations described with reference to FIG. 2 or FIG. 8, but the present disclosure is not limited thereto and may be performed by an electronic apparatus including various modified configurations.

In the above-described embodiments, it has been described that when operation states of components selected as calibration targets are sequentially changed and driven, operation states are sequentially changed from a minimum setting value to a maximum setting value. However, minimum and maximum setting values for each component may vary depending on refrigerator modes. In other words, when a minimum setting value and a maximum setting value are set to an excessively low range, rotational speeds of a compressor or fans are reduced. Therefore, this may be inappropriate in a rapid cooling mode or a rapid freezing mode.

In this case, when the user directly sets the RPMs of the respective components as in the above-described various embodiments, it may be difficult to implement, as is, a device mode previously used by the user (for example, a rapid cooling mode). When such a situation occurs, the electronic apparatus or the terminal apparatus may provide a message indicating that the setting information set by the user is unsuitable for the current device mode, and may perform the setting after receiving confirmation from the user.

Alternatively, the electronic apparatus may prevent the user from setting an impossible setting value by driving components while changing operation states within a range configurable under a current device mode.

According to various embodiments as described above, noise and/or vibration generated during driving of components of an electronic apparatus may be diagnosed and calibrated directly by a user or remotely by an external apparatus or an A/S engineer. Accordingly, unnecessary component replacement may be minimized, and noise and/or vibration may be rapidly and easily calibrated. In particular, since a user may diagnose noise and/or vibration based on the user’s subjective feeling and calibrate the same to a desired state, user satisfaction may be significantly improved.

In the above-described embodiments, a case in which the electronic apparatus is implemented as a refrigerator has been mainly described. However, the above-described embodiments may also be applied to diagnose noise and/or vibration of components of various electronic apparatuses other than a refrigerator.

In addition, although various embodiments have been described above, each embodiment does not necessarily need to be implemented independently, and may be implemented together in a single apparatus in combination, entirely or partially, with at least one other embodiment.

In addition, the above-described various embodiments may be implemented as software including instructions stored in machine-readable storage media, which can be read by machine (e.g.: computer). The machine refers to a device that calls instructions stored in a storage medium, and can operate according to the called instructions, and the device may include an electronic apparatus, a terminal apparatus, a server apparatus, etc. according to the aforementioned embodiments. In case an instruction is executed by a processor, the processor may perform a function corresponding to the instruction by itself, or by using other components under its control. The instruction may include a code that is generated or executed by a compiler or an interpreter. The machine-readable storage medium may be provided in the form of a non-transitory storage medium. Here, the term ‘non-transitory’ means that the storage medium is tangible without including a signal, and does not distinguish whether data are semi-permanently or temporarily stored in the storage medium.

In addition, according to an embodiment, the methods according to various embodiments disclosed in the present disclosure may be included and provided in a computer program product. The computer program product may be traded as a product between a seller and a purchaser. The computer program product may be distributed in the form of a storage medium (e.g., compact disc read only memory (CD-ROM)) that is readable by devices, or may be distributed through an application store (e.g., PlayStore^{TM}). In the case of an online distribution, at least part of the computer program product may be at least temporarily stored in a storage medium readable by a machine such as a server of the manufacturer, a server of an application store, or memory of a relay server or may be temporarily generated.

Further, components (e.g., modules or programs) according to various embodiments of the present disclosure may include a single entity or a plurality of entities, and some of the corresponding sub-components described above may be omitted or other sub-components may be further included in the various embodiments. Alternatively or additionally, some components (e.g., modules or programs) may be integrated into one entity and perform the same or similar functions performed by each corresponding component prior to integration. Operations performed by the modules, the programs, or the other components according to the various embodiments may be executed in a sequential manner, a parallel manner, an iterative manner, or a heuristic manner, or at least some of the operations may be performed in a different order or be omitted, or other operations may be added.

Although preferred embodiments of the present disclosure have been shown and described above, the disclosure is not limited to the specific embodiments described above, and various modifications may be made by one of ordinary skill in the art without departing from the gist of the disclosure as claimed in the claims, and such modifications are not to be understood in isolation from the technical ideas or prospect of the disclosure.

What is claimed is:

1. An electronic apparatus comprising:
a plurality of components;
memory configured to store first setting information for operations of the plurality of components; and
at least one processor,
wherein the at least one processor is configured to:
based on executing a test mode for diagnosing at least one of a noise or vibration, sequentially operate the plurality of components and select at least one of the plurality of components as a calibration target based on at least one of noise states or vibration states of the plurality of components;
operate the calibration target while sequentially changing an operation state with a plurality of operation states of the calibration target;
select one operation state from the plurality of operation states; and
based on the selected one operation state being selected, store in the memory, updated setting information corresponding to the selected one operation state.

2. The electronic apparatus of claim 1, wherein each of the first setting information stored in the memory is individually set for each of the plurality of components and is changeable according to a user operation; and
wherein the processor is further configured to:
based on executing, while the electronic apparatus is operating, a first test mode for calibrating at least one of a current noise state or a current vibration state, control each of the plurality of components to sequentially operate in an operation state corresponding to the stored updated setting information; and
based on executing a second test mode for diagnosing a cause of at least one of the current noise state or the current vibration state, control each of the plurality of components to sequentially operate in an operation state corresponding to default setting information stored in the memory.

3. The electronic apparatus of claim 1, further comprising:
a communicator configured to perform communication with a terminal apparatus,
wherein the processor is further configured to:
based on receiving from the terminal apparatus, through the communicator, a first control signal for initiating the test mode, execute the test mode and sequentially operate the plurality of components according to the setting information stored in the memory;
based on receiving, through the communicator, a second control signal for selecting at least one of the plurality of components as the calibration target, operate the calibration target while sequentially changing an operation state of the calibration target; and
based on receiving, through the communicator, a third control signal for selecting a specific operation state among operations states of the calibration target, store updated setting information corresponding to the specific operation state in the memory.

4. The electronic apparatus of claim 1, further comprising:
a display,
wherein the processor is further configured to:
control the display to display a UI screen;
based on a first control command for initiating the test mode being input through the UI screen, execute the test mode, sequentially drive the plurality of components, and control the display to display information on one of the plurality of components being driven;
based on a second control command for selecting at least one of the plurality of components as the calibration target being input through the UI screen, sequentially drive the calibration target while sequentially changing an operation state of the calibration target, and control the display to display information on the operation states of the calibration target; and
based on a third control command for selecting a specific operation state among operation states of the calibration target being input through the UI screen, store updated setting information corresponding to the specific operation state in the memory.

5. The electronic apparatus of claim 1, further comprising:
at least one sensor configured to detect at least one of noise or vibration,
wherein the processor is configured to:
based on the test mode being executed, identify at least one of a noise state or vibration state of each of the plurality of components based on sensing values of the at least one sensor while sequentially driving the plurality of components;
select at least one of the plurality of components as the calibration target based on identification results for each of the plurality of components;
while driving the calibration target and sequentially changing an operation state of the calibration target, identify at least one of the noise or the vibration states of the calibration target for each operation state of the calibration target based on sensing values of the at least one sensor;
select a specific operation state among the operation states of the calibration target based on identification results identified for each of the operation states of the calibration target; and
store updated setting information corresponding to the specific operation state in the memory.

6. The electronic apparatus of claim 1, further comprising:
at least one sensor configured to detect at least one of noise or vibration; and
a communicator configured to perform communication with an external apparatus,
wherein the processor is configured to:
based on a first control signal for initiating the test mode being received from the external apparatus through the communicator, execute the test mode, sequentially drive the plurality of components, identify at least one of a noise state or vibration state of each component based on sensing values of the at least one sensor, and transmit the identification results to the external apparatus through the communicator;
based on a second control signal for selecting at least one of the plurality of components as the calibration target being received through the communicator, sequentially drive the component selected as the calibration target while sequentially changing an operation state thereof, identify at least one of the noise state or vibration state of the calibration target for each operation state of the plurality of operation states of the calibration target based on sensing values sensed by the at least one sensor while driving the calibration target while sequentially changing an operation state thereof, and transmit the identification results to the external apparatus through the communicator; and
based on, receiving, through the communicator, a third control signal for selecting a specific operation state among the plurality of operation states of the calibration target, store setting information corresponding to the specific operation state in the memory.

7. The electronic apparatus of claim 1, wherein the electronic apparatus is a refrigerator;
wherein the plurality of components includes a compressor and a plurality of fans; and
wherein the setting information includes revolutions per minute (RPM) information of the plurality of components.

8. A terminal apparatus for diagnosing an operation state of an electronic apparatus, comprising:
a communicator configured to perform communication with the electronic apparatus;
memory storing an application for controlling operations of the electronic apparatus;
a display; and
at least one processor,
wherein the at least one processor is configured to:
execute the application and control the display to display a UI screen corresponding to the electronic apparatus;
based on a menu being selected, on the UI screen, for diagnosing at least one of a noise or vibration of the electronic apparatus, control the communicator to transmit a first control signal to the electronic apparatus for initiating a test mode;
based on at least one component being designated through the UI screen while executing the test mode in the electronic apparatus and sequentially operating a plurality of components embedded in the electronic apparatus, control the communicator to transmit a second control signal to the electronic apparatus for operating the designated component while sequentially changing an operation state with a plurality of operation states of the designated component;
select, through the UI screen, one operation state from the plurality of operation states of the designated component; and
based on the selected one operation state being a specific operation state among the plurality of operation states of the designated component, control the communicator to transmit, to the electronic apparatus, setting information corresponding to the selected one operation state.

9. A noise and vibration calibration method of an electronic apparatus including a plurality of components, the method comprising:
based on executing a test mode for diagnosing a noise or vibration , sequentially operating a plurality of components;
based on at least one of the plurality of components being selected as a calibration target based on at least one of noise states or vibration states of each of the plurality of components, operating the calibration target while sequentially changing an operation state with a plurality of operation states of the calibration target;
based on selecting a specific operation state among the plurality of operations states of the calibration target, storing updated setting information corresponding to the calibration target; and
based on the test mode being terminated, operate the plurality of components based on the stored updated setting information.

10. The method of claim 9, wherein the sequentially operating the plurality of components comprises:
based on executing, while the electronic apparatus is operating, a first test mode for calibrating a current noise state or a current vibration state, controlling each of the plurality of components to sequentially operate in an operation state corresponding to the updated setting information stored in the electronic apparatus; and
based on executing, while the electronic apparatus is operating, a second test mode for diagnosing and calibrating a cause of at least one of a noise or vibration, control each of the plurality of components to sequentially operate in an operation state corresponding to default setting information.

11. The method of claim 9, wherein the operating the calibration target while sequentially changing an operation state of the calibration target comprises:
Receiving, from a terminal apparatus, a first control signal for selecting at least one of the plurality of components as the calibration target; and
operating the calibration target by the first control signal while sequentially changing an operation state of the calibration target; and
wherein the storing updated setting information of the calibration target comprises:
based on receiving, from the terminal apparatus, a second control signal for selecting a specific operation state among a plurality of operations states of the calibration target, storing setting information corresponding to the specific operation state.

12. The method of claim 9, further comprising:
displaying a UI screen;
wherein the sequentially operating the plurality of components comprises:
based on a first control command, for initiating the test mode, being input through the UI screen, executing the test mode; and
sequentially operating the plurality of components, and displaying information on one of the plurality of components being operated;
wherein the operating the calibration target while sequentially changing the operation state of the calibration target comprises:
based on a second control command, for selecting at least one of the plurality of components as the calibration target, being input through the UI screen, operating the calibration target while sequentially changing the operation state of the calibration target; and
displaying information on the plurality of operation states of the calibration target on the UI screen; and
wherein the storing the updated setting information of the calibration target comprises:
based on inputting, through the UI screen, a third control command for selecting the specific operation state among the plurality of operation states of the calibration target, storing the updated setting information corresponding to the specific operation state.

13. The method of claim 9 further comprising,
wherein the sequentially driving a plurality of components comprises:
while the test mode is executed to sequentially operate the plurality of components, identify at least one of the noise states or vibration states of each of the plurality of components; and
wherein the operating the calibration target while sequentially changing the operation state with the plurality of operation states of the calibration target comprises:
selecting at least one of the plurality of components as the calibration target based on identification results identified for each of the plurality of components;
while operating the calibration target and sequentially changing an operation state of the calibration target, identifying at least one of the noise or the vibration states of the calibration target for each operation state; and
selecting a specific operation state among the plurality of operation states of the calibration target based on the identification results identified for each of the plurality of operation states.

14. The method of claim 9 further comprising:
wherein the sequentially driving a plurality of components comprises:
based on a first control signal, for initiating the test mode, being received froman external apparatus, executing the test mode, and sequentially operating the plurality of components;
identifying at least one of the noise states or vibration states of the plurality of components based on sensing values sensed by at least one sensor while sequentially operating the plurality of components; and
transmitting identification results to an external apparatus;
wherein the operating the calibration target while sequentially changing an operation state of the calibration target comprises:
based on receiving, from the external apparatus, a second control signal for selecting at least one of the plurality of components as the calibration target, operating the calibration target while sequentially changing an operation state of the calibration target;
identifying at least one of the noise state or the vibration states of the calibration target for each operation state of the plurality of operation states of the calibration target based on sensing values sensed by the at least one sensor while operating the calibration target and sequentially changing the operation state with the plurality of operation states of the calibration target; and
transmitting identification results identified for each operation state of the plurality of operation states of the calibration target to the external apparatus; and
wherein the storing the updated setting information of the calibration target comprises:
based on receiving, from the external apparatus, a third control signal for selecting a specific operation state among the plurality of operation states of the calibration target, store the updated setting information corresponding to the specific operation state.

15. The method of claim 9, wherein the electronic apparatus is a refrigerator;
wherein the plurality of components includes a compressor and a plurality of fans; and
wherein the updated setting information includes revolutions per minute (RPM) information of the plurality of components.
